(19) United States
(12) Patent Application Publication
(10) Pub. No.: US 2026/0138583 A1
(43) Pub. Date: May 21, 2026

(54) METHOD AND DEVICE FOR CARRYING OUT AT LEAST ONE VEHICLE FUNCTION OF A VEHICLE, AND METHOD AND DEVICE FOR CREATING A TRAINED MACHINE LEARNING EXHAUST GAS DETERMINATION MODEL

(71) Applicant: Volkswagen Aktiengesellschaft, Wolfsburg (DE)

(72) Inventors: Max SCHUETTENHELM, Wolfsburg (DE); Thomas GARBE, Wolfsburg (DE); Karsten MICHELS, Wolfsburg (DE)

(73) Assignee: Volkswagen Aktiengesellschaft, Wolfsburg (DE)

(21) Appl. No.: 19/389,120

(22) Filed: Nov. 14, 2025

(30) Foreign Application Priority Data
Nov. 15, 2024 (DE) 10 2024 210 991.6

(51) Int. Cl. B60W 10/06; B60W 10/30

(52) U.S. Cl. CPC B60W 10/06; B60W 10/30; B60W 2530/213; B60W 2710/06; B60W 2710/30

(57) ABSTRACT

A method for carrying out at least one vehicle function of a vehicle, depending on a fuel mixture to be combusted. Fuel mixture data is ascertained concerning the fuel mixture to be combusted. The ascertained fuel mixture data being characteristic of at least one property of the fuel mixture to be combusted. At least one vehicle variable is ascertained for carrying out the at least one vehicle function based on the ascertained fuel mixture data using a trained machine learning exhaust gas determination model. The trained machine learning exhaust gas determination model, using the ascertained fuel mixture data as an input variable, generates at least one combustion variable as an output variable. The combustion variable being characteristic of at least one combustion property of the fuel mixture to be combusted. The at least one vehicle function is performed based on the ascertained vehicle variable.

This nonprovisional application claims priority under 35 U.S.C. § 119(a) to German Patent Application No. 10 2024 210 991.6, which was filed in Germany on Nov. 15, 2024, and which is herein incorporated by reference.

### BACKGROUND OF THE INVENTION

### Field of the Invention

The present invention relates to a method and a device for carrying out at least one vehicle function of a vehicle, depending on a fuel mixture to be combusted. The present invention further relates to a method and a device for creating a trained machine learning exhaust gas determination model.

The present invention relates to a method for carrying out a vehicle function depending on a fuel mixture that is present at the time in the fuel tank of the vehicle, in particular a drive operating strategy being adapted to this fuel mixture.

### Description of the Background Art

It is generally known from the prior art that operating parameters of a drive train of a vehicle for carrying out a vehicle function are adapted to the commonly used fuels after production of the vehicle. For example, operating parameters such as compression, injection pressure, or the like may be adjusted. Such adjustments generally are not adapted during the operating lifetime of the vehicle. Thus far, commercial fuels have been available in relatively narrow standard limits concerning their composition and properties, so that a one-time adjustment of the operating parameters is regarded as sufficient. However, this situation will change in the future due to provision of regenerative manufacturing options as well as synthetic fuels, which will expand available offerings.

It is known from the prior art only to detect a fuel to be combusted, using a fuel sensor. For this purpose, for example a fuel may be classified and compared to data that are stored for this fuel.

An adaptive control system for the fuel properties for controlling the power of an engine, for example an internal combustion engine, is known from US 2006/0080025 A1. An on-board fuel classifier classifies the fuel that the engine is using at the time. Based on the stored properties for this fuel, the system selects the optimal engine control parameters.

Systems and methods for managing an engine-driven electric generator are known from US 2014/0152006 A1. An example method may include populating an efficiency database with data concerning the fuel provided and the electrical power output for the engine-driven electric generator. The method may also include receiving a desired electrical power output of the engine-driven electric generator. The method may also include adjusting the fuel provided to the engine-driven electric generator in order to generate the desired electrical power output, using the efficiency database.

A calibration system for calibrating an internal combustion engine as a function of a pumped fuel is known from DE 10 2022 133 236, the calibration system including a control unit for controlling the internal combustion engine, an external computer system with an artificial intelligence (AI) module, and a receiver for receiving at least one value of a calibration parameter from the computer system, the AI module being configured to calculate the value of the calibration parameter using a database of the computer system and based on the information concerning the pumped fuel, the database being created as a function of setting values of a further control unit for controlling a further internal combustion engine, collected during operation of the further internal combustion engine, using different fuels, and/or as a function of simulation data obtained using simulations of different operating modes of the internal combustion engine, each with different fuels, and the control unit being adjustable as a function of the value of the calibration parameter.

However, no method is known from the prior art which allows flexible adaptation of the operating parameters for carrying out a vehicle function, depending on a fuel that is present at the time in the fuel tank, and in particular which allows adaptation of an operating strategy during ongoing operation of the vehicle.

For the future use of regenerative fuels or synthetic fuels, there is a need for a method for carrying out at least one vehicle function of a vehicle, depending on a fuel mixture that is present at the time in the fuel tank of the vehicle.

### SUMMARY OF THE INVENTION

It is therefore an object of the present invention to overcome the disadvantages known from the prior art, and to provide a method and a device for carrying out at least one vehicle function depending on a fuel mixture to be combusted, and a method and a device for creating a trained machine learning exhaust gas determination model.

In a method according to the invention for carrying out at least one vehicle function of a vehicle depending on a fuel mixture to be combusted which results in particular from a fueling operation, in one step, fuel mixture data concerning the fuel mixture to be combusted are ascertained, the ascertained fuel mixture data being characteristic of at least one property of the fuel mixture to be combusted. The fuel mixture to be combusted can be a fuel mixture that is present in a fuel tank of the vehicle and that is to be combusted (in an internal combustion engine) to drive the vehicle. The fuel mixture can be a fuel mixture that has been obtained as the result of a fueling operation.

In a further step of the method according to the invention, at least one vehicle variable for carrying out the at least one vehicle function is ascertained based on the ascertained fuel mixture data, using a trained machine learning exhaust gas determination model, wherein the trained machine learning exhaust gas determination model, using the ascertained fuel mixture data as an input variable, generates at least one combustion variable as an output variable, the combustion variable being characteristic of at least one combustion property of the fuel mixture to be combusted. The at least one vehicle variable can be ascertained based on at least one combustion variable. In a further step of the method according to the invention, the at least one vehicle function is carried out based on the ascertained vehicle variable. The vehicle function can be a drive function of the vehicle, and the vehicle variable is characteristic of an adjustment variable or an operating parameter of the drive train of the vehicle. For a fuel mixture that is present at the time, at least one adjustment variable of the drive train can be adapted, and consequently an adaptation of the drive operating strategy takes place.

In other words, fuel mixture data concerning the fuel mixture to be combusted, present in the fuel tank of the vehicle, are ascertained, and based on these data a vehicle variable is ascertained which is used to carry out at least one vehicle function of the vehicle, an operating parameter of the drive train preferably being adapted to the fuel mixture at the time. In other words, an adjustment variable of the vehicle for carrying out the vehicle function, for example the drive of the vehicle by combustion of the fuel mixture, is adapted to the fuel mixture present at the time. The proposed method may be used for all vehicles that have an internal combustion engine. In other words, the proposed method may be used with vehicles having a conventional internal combustion engine, and also with hybrid vehicles (mild hybrid electric vehicles (MHEVs) and plug-in hybrid electric vehicles (PHEVs)).

The fuel mixture to be combusted can include at least one first fuel and one second fuel, the first fuel preferably being a fuel that is present in the fuel tank of the vehicle (prior to the fueling operation), and the second fuel preferably being a pumped fuel that can be mixed with the first fuel, in particular during a subsequent fueling operation. In other words, the fuel mixture to be combusted is formed from a residual fuel remaining in the fuel tank (prior to filling), mixed with a pumped fuel. The method according to the invention can be applied during and in particular immediately after a, preferably each, fueling operation. In other words, preferably after each fueling operation, a vehicle variable is ascertained and the vehicle function is carried out (with adaptation) based on this vehicle variable.

The first fuel and/or second fuel and/or the fuel mixture are/is a gasoline engine fuel, in particular gasoline. The method described within the scope of the present invention is also applicable for other fuels, for example, diesel fuel as a fuel, with appropriate adaptations.

The fuel mixture data concerning the fuel mixture to be combusted can be ascertained. In this context, ascertainment can be understood to mean collection (using a detection device or fuel identification device, for example) or retrieval of data or ascertainment based on computer-assisted or computer-implemented methods. The fuel mixture data are preferably ascertained based on first fuel data and second fuel data. In one preferred method (for ascertaining the fuel mixture data concerning the fuel mixture to be combusted), first fuel data and second fuel data are ascertained and/or retrieved and/or collected.

First fuel data and second fuel data can be ascertained, the first fuel data being characteristic of at least one property of the first fuel, and the second fuel data being characteristic of at least one property of the second fuel. In one advantageous method, the ascertainment of the fuel mixture data takes place based on the first fuel data and second fuel data.

The at least one property of the first fuel and/or of the second fuel and/or of the fuel mixture can be a composition of the first fuel and/or of the second fuel and/or of the fuel mixture, and/or is a fuel variable (physicochemical variable) of the first fuel and/or of the second fuel and/or of the fuel mixture, and/or is a volume or a mass of the first fuel and/or of the second fuel and/or of the fuel mixture.

The first fuel data can be characteristic of the first fuel and in particular of a composition of the first fuel and/or of a volume or a quantity of the first fuel and/or of a mass of the first fuel and/or of a volume fraction and/or mass fraction of the first fuel in the fuel mixture to be combusted. The second fuel data are preferably characteristic of the second fuel and in particular of a composition of the second fuel and/or of a volume or a quantity of the second fuel and/or of a mass of the second fuel and/or of a volume fraction and/or mass fraction of the second fuel in the fuel mixture to be combusted.

The first fuel data and second fuel data in each case can include at least one, and preferably a plurality of; analysis variables and fractional portions associated with the analysis variables. In one preferred method, the first fuel data and/or second fuel data include at least one, and preferably a plurality of, fuel variables. In one preferred method, the first fuel data and/or second fuel data include a quantity variable or a volume variable, the quantity variable or volume variable being characteristic of a quantity or volume, respectively, of the first fuel and/or second fuel. The quantity variable or volume variable can be characteristic of a portion of the first fuel and/or second fuel relative to the total quantity or the total volume, respectively, of the fuel mixture to be combusted. The first fuel data and/or the second fuel data can, in each case, include a mass variable, the mass variable being characteristic of a mass fraction of the first fuel and/or second fuel in the fuel mixture.

The first fuel and/or the second fuel and/or the fuel mixture to be combusted can each preferably include more than one compound, component, or substituent, and preferably a plurality of different compounds, components, or substituents. The analysis variable can be characteristic of a group of compounds from the first fuel and/or the second fuel and/or the fuel mixture to be combusted which have at least one predefined functionality. The fractional portion can be characteristic of a quantity fraction of the compounds that are present in the particular fuel and grouped in the group characterized by the analysis variable.

The analysis variable and the fractional portion associated with same preferably refer to a (predefined and/or predefinable) component of the fuel mixture or of the first or second fuel, for example a predefined group of compounds in the particular fuel. It would also be conceivable for the analysis variable to refer to a specific chemical compound, and for the associated fractional portion to refer to the fraction of this specific chemical compound in the particular fuel.

The analysis variable indicates the type of (predefined and/or predefinable) component, and thus identifies the type of component. In other words, the analysis variable is used as an identifier for a component of the fuel.

The fractional portion can be, for example, characteristic of a fraction of the component in the particular fuel that is specified or characterized or identified by the analysis variable. In other words, the fractional portion represents a measure for the fraction of the component (such as a predefined group of compounds) in the particular fuel that is identified or characterized by the analysis variable. The fractional portion can be characteristic of a volumetric fraction (such as at a predefined and/or predefinable temperature at 15° C., for example, and/or a pressure and/or other parameters). However, it is also conceivable for the fractional portion to be characteristic of a quantitative fraction and/or a mass fraction.

The particular fuel data or fuel mixture data (for the particular fuel or for the particular fuel mixture) can include a plurality of analysis variables (which in particular are mutually pairwise distinct) and the fractional portions associated with each of the analysis variables. Exactly one fractional portion can be associated with each analysis variable. The analysis variables are preferably analysis variables as described in each case above, which particularly preferably refer in each case to different, in particular mutually pairwise distinct, components such as the predefined group of compounds).

The analysis variable can be in each case characteristic of a group of compounds (preferably hydrocarbon compounds and/or oxygen-containing compounds) having at least one predefined functionality and/or a predefined carbon number (or multiple predefined carbon numbers). In other words, by providing the analysis variable it is possible to identify or specify the, or preferably all, compounds having at least one predefined functionality (which may occur commonly or in principle in particular in fuels, for example). The fuel mixture data or the first fuel data and/or the second fuel data in particular include in each case information concerning the hydrocarbons or hydrocarbon groups and/or oxygenates (or oxygen-containing compounds) in the particular fuel or fuel mixture.

For example, the analysis variable could be characteristic of a group of hydrocarbons comprising hydrocarbons (in particular all hydrocarbons occurring in a fuel, for example) having an aromatic functionality and hydrocarbons having a (cyclol)olefin functionality.

The fractional portion can be characteristic of a quantity fraction of the compounds, present in the fuel mixture or fuel, that are grouped in the group characterized (or identified or identifiable) by the analysis variable. The quantity fraction preferably refers to a quantity ratio (in particular a volumetric ratio and/or a mass ratio) of the compounds that are present in a predefined total quantity of the particular fuel or fuel mixture and grouped in the group characterized by the analysis variable, to the total quantity of the particular fuel. In particular, the particular fuel data or fuel mixture data (preferably by use of the values of the fractional portions that are associated with the particular analysis variables) are in each case characteristic of the composition of the particular fuel or fuel mixture.

The first fuel data and/or the second fuel data and/or the fuel mixture data include at least one fuel variable that is characteristic of at least one fuel property, the at least one fuel property preferably being selected from a group of fuel properties comprising ignition quality, energy content, density, vapor pressure, boiling properties, viscosity, knock resistance, cetane number (CN), characteristic values such as points on a distillation curve, a Yield Sooting Index (YSI), a Research Octane Number (RON), a Motor Octane Number (MON), a Front Octane Number (FON), a Street Octane Number (SON), and the like as well as combinations thereof. In particular the Yield Sooting Index (YSI), in particular the soot yield index, is characteristic of a quantity of soot that is formed by a fuel when it is injected at a low concentration into a methane-air base flame.

The first fuel data and/or second fuel data can be obtained from a reformer analysis and/or a spectroscopic analysis. In a further example method, the first fuel data and/or second fuel data that are ascertained and/or to be ascertained are, or have been, generated using an in particular multidimensional gas chromatographic (experimental) measurement process for determining the hydrocarbon groups and/or the oxygen-containing compounds of the particular fuel

For this purpose, the method that is normed or standardized in DIN EN ISO 22854 for determining the hydrocarbon groups and the oxygen-containing compounds in gasoline engine fuels and in ethanol fuel (E85) (multidimensional gas chromatographic method: ISO/DIS 22854:2020) is used. With regard to disclosure of this measurement process according to DIN EN ISO 22854 (in particular for ascertaining and/or collecting the first fuel data and/or second fuel data and/or ascertaining at least one fractional portion and preferably all fractional portions), reference is made to ISO/DIS 22854:2020, the contents of which are hereby incorporated into this patent application.

The ascertainment of the fuel properties or the ascertainment of the data concerning the at least one fuel property can be to take place based on the data ascertained under ISO 22854 (for the first fuel data and/or second fuel data or the fuel mixture data of the particular fuels). The special feature is the division of the fuel components into functional groups, and the subdivision of these functional groups according to the number of carbon atoms or the exact designation of the relevant oxygenates.

The analysis variable can be characteristic of a group of hydrocarbons. The at least one predefined functionality (or the multiple predefined functionalities) is/are preferably selected from a group comprising an (n-/iso)paraffin functionality, a naphthene functionality, an (n-/iso-)olefin functionality, a cyclo(olefin) functionality, and/or an aromatic functionality. The group of hydrocarbons having multiple predefined functionalities can be understood in particular to mean that this group includes all hydrocarbons which in any case have one of the multiple predefined functionalities.

In other words, the first fuel data and/or second fuel data and/or fuel mixture data preferably include information concerning the hydrocarbons (in particular information about their (in particular volume) fraction in the fuel) with regard to a functionality of the hydrocarbons, the at least one predefined functionality preferably being selected from a group comprising an (n-/iso)paraffin functionality, a naphthene functionality, an (n-/iso-)olefin functionality, a cyclo(olefin) functionality, and/or an aromatic functionality.

The analysis variable can be characteristic of a group of oxygenates, wherein the at least one functionality is an ether functionality and/or an alcohol functionality, and/or wherein the analysis variable is characteristic of a structure of the carbon chain and/or at least and preferably exactly one type of alcohol.

An (in particular exactly one) analysis variable can be characteristic of a group of oxygenates having an ether functionality. Additionally or alternatively, an (in particular exactly one) analysis variable can be characteristic of a group of oxygenates having an alcohol functionality.

At least one, and preferably the, analysis variable (particularly preferably multiple analysis variables) is/are characteristic of a group of compounds, in particular hydrocarbon compounds, having a predefined carbon number. In particular, within a functionality preferably two or more carbon numbers are consolidated (to form a joint group of compounds of which the analysis variable is characteristic), preferably sequentially, for example paraffin C₃+C₄. This offers the advantage that the number of data sets in the analysis data set is decreased.

Each combination of a functionality and a carbon number (C number) (or multiple predefined carbon numbers) preferably represents an independent analysis variable or an independent identifier, which together, preferably with their respective fractions (or fractional portions), result in the analysis data set. The fraction of an identifier in the mixture can be associated with each identifier (in particular over the fractional portion).

The first fuel data and/or second fuel data and/or fuel mixture data can have at most 20, preferably at most 15, preferably at most 13, (mutually pairwise distinct) analysis variables for oxygenates. The first fuel data and/or second fuel data and/or fuel mixture data preferably have at most 15, preferably at most 10, preferably at most 9, different analysis variables, and particularly preferably have exactly one analysis variable for alcohols. The first fuel data and/or second fuel data and/or fuel mixture data preferably have at most 5, preferably at most 4, (mutually pairwise distinct) analysis variables, and particularly preferably have exactly one analysis variable for ether.

The first fuel data and/or second fuel data and/or fuel mixture data can have at most 15, preferably at most 9, particularly preferably at most 6, different analysis variables for (n-/iso)paraffins. The first fuel data and/or second fuel data and/or fuel mixture data preferably have at most 6, preferably exactly one, analysis variable(s) for naphthene. The first fuel data and/or second fuel data and/or fuel mixture data can have at most 8, preferably at most 7, preferably at most 5, preferably exactly 5, different analysis variables for (n-/iso-)olefins. The first fuel data and/or second fuel data and/or fuel mixture data preferably have at most 6, particularly preferably exactly 6, different analysis variables for (cyclo)olefins. The first fuel data and/or second fuel data and/or fuel mixture data preferably have at most 6, and particularly preferably exactly 6, different analysis variables for aromatics.

The above-mentioned maximum numbers for the particular analysis variables in each case offer (individually or in combination) the advantage that, on the one hand, typical data that are customarily determined in the manufacture of the fuels may be used, and no further measurement data for ascertaining the first fuel data and/or second fuel data need to be generated or determined, and on the other hand, the greatest possible reduction of the data sets of the first fuel data and/or second fuel data and/or fuel mixture data may be made.

The first fuel data and/or second fuel data and/or fuel mixture data preferably have a fractional portion (an analysis variable and a fractional portion associated with this analysis variable) that is characteristic of (all) paraffins having carbon numbers 6 or 7. This statement (and correspondingly, analogous statements made below concerning further functionalities/carbon numbers) can be understood here in particular to mean that for the paraffins having carbon number 6 and for the paraffins having carbon number 7 in the first fuel data and/or second fuel data and/or fuel mixture data, (only) one joint analysis variable is provided. The first fuel data and/or second fuel data and/or fuel mixture data thus in particular have no (independent) analysis variable (and a fractional portion associated with same) that is characteristic of paraffins having only the carbon number 6. In addition, the first fuel data and/or second fuel data and/or fuel mixture data in particular also have no (independent) analysis variable (and a fractional portion associated with same) that is characteristic of paraffins having only the carbon number 7. In particular. based (only) on the first fuel data and/or second fuel data and/or fuel mixture data, a distinction cannot be made between the paraffins having carbon number 6 and the paraffins having carbon number 7 (or also their fractional portion).

Additionally or alternatively, the first fuel data and/or second fuel data and/or fuel mixture data can have a fractional portion (an analysis variable and a fractional portion associated with this analysis variable) that is characteristic of (all) paraffins having carbon numbers 8, 9, or 10. Additionally or alternatively, the first fuel data and/or second fuel data and/or fuel mixture data can have a fractional portion (an analysis variable and a fractional portion associated with this analysis variable) that is characteristic of (all) paraffins having carbon numbers of at least 11. Additionally or alternatively, the first fuel data and/or second fuel data and/or fuel mixture data preferably each have a separate fractional portion (an analysis variable and a fractional portion associated with this analysis variable) for each of the carbon numbers 3, 4, and 5.

Additionally or alternatively, the first fuel data and/or second fuel data and/or fuel mixture data preferably in each case can have a fractional portion (an analysis variable and a fractional portion associated with this analysis variable) for naphthene having carbon numbers between 5 and 10, so that all carbon numbers are advantageously consolidated.

Additionally or alternatively, the first fuel data and/or second fuel data and/or fuel mixture data preferably in each case can have a fractional portion (an analysis variable and a fractional portion associated with this analysis variable) for (n-/iso-)olefins having carbon numbers 4 or 5. Additionally or alternatively, the first fuel data and/or second fuel data and/or fuel mixture data preferably in each case have a separate fractional portion (an analysis variable and a fractional portion associated with this analysis variable) for (n-/iso-)olefins having carbon numbers 7 or 8. Additionally or alternatively, the first fuel data and/or second fuel data and/or fuel mixture data preferably in each case have a (respectively) separate fractional portion (an analysis variable and a fractional portion associated with this analysis variable) for (n-/iso-)olefins having the respective individual carbon numbers 3 and 6.

Due to the further aggregation of the data, for example via the consolidation of Cₙ and Cₙ₊₁ (within a functionality, consolidation of compounds having sequential carbon numbers) to form a new (joint) group (which is characterized by a single analysis variable), a further reduction in the data volume is advantageously achieved.

All (cyclo)olefins that are characterized by exactly one analysis variable are preferably consolidated to form a joint group. In the first fuel data and/or second fuel data and/or fuel mixture data, within the scope of the analysis variables (and the associated fractional portions) a distinction is not made between (cyclo)olefins having various carbon numbers.

Additionally or alternatively, within the (cyclo)olefins and/or aromatics preferably no carbon numbers are consolidated (to form a joint group that is characterized by a single analysis variable). In an example, the first fuel data and/or second fuel data and/or fuel mixture data may have no analysis variable(s) that is/are characteristic of (cyclo)olefins and/or aromatics, so that the data set may be further reduced. It has been found that these compounds have only a minor influence on the fuel properties.

The analysis variable, and preferably the fractional portion associated with same, can be characteristic of a single chemical compound. In other words, for each chemical compound occurring in the fuel or fuel mixture, the first fuel data and/or second fuel data and/or fuel mixture data may contain their own independent analysis variable and a fractional portion associated with each. In this case, although the analysis data sets contain a much larger quantity of data and determining the analysis variables or fractional portions is more complicated, a maximum amount of information is obtained.

The ascertainment of the fuel mixture data can take place based on the first fuel data and second fuel data. The first fuel data and second fuel data preferably in each case contain a plurality of analysis variables and the fractional portions associated with the analysis variables. The first fuel data and second fuel data preferably in each case contain data concerning a volume or its volume fraction in the fuel mixture. The first fuel data and second fuel data in each case may contain data concerning a mass, and preferably for a mass fraction of the first fuel and/or second fuel in the fuel mixture. In other words, the ascertained first fuel data and second fuel data are characteristic of a composition of the particular fuels and their fraction in the fuel mixture.

The ascertainment of the fuel mixture data can take place using a mixing model based on the first fuel data and second fuel data. In one preferred method, the mixing model or a selection of a suitable mixing model is a function of the (used or available) first fuel data and second fuel. The first fuel data and second fuel data in each case can include a plurality of analysis variables and fractional portions, and preferably include no fuel variables. In other words, in this example the first fuel data and second fuel data are characteristic of a composition of the first fuel and second fuel, whereas no data concerning a fuel property (for example, vapor pressure, density, etc.) are contained. In this case, the fuel mixture data are preferably ascertained using a mathematical model, in particular combinatorics.

In other words, based on the analysis variables, fractional portions, and their volume variables or mass variables (particular fraction in the fuel mixture) contained in the first fuel data and second fuel data, a composition of the (new) fuel mixture may be easily and directly deduced. In this case, the ascertained fuel mixture data preferably include a plurality of analysis variables and fractional portions, but preferably no fuel variables.

The first fuel data and second fuel data additionally can include at least one, and preferably a plurality of, fuel variable(s) (for example, information concerning a vapor pressure, an octane number, a density, or the like). It is not possible by use of simple combinatorics to ascertain at least one and preferably a plurality of fuel variable(s) for the fuel mixture. In particular, the individual variables mutually influence one another, and simple linear relationships are not present. A more complex mixing model such as a trained machine learning model must be used. Such a complex mixing model in the form of a trained fuel property determination model is known, for example, from DE 10 2022 207 017 A1 by the applicant. Refence is made to the disclosure of DE 10 2022 207 017 A1, the contents of which are hereby incorporated by reference.

The first fuel data can be retrieved, for example, from a nonvolatile memory device of the vehicle. In an example, the first fuel data are characteristic of a (residual) fuel present in the fuel tank of the vehicle (prior to fueling). The first fuel data are preferably stored on the nonvolatile memory device of the vehicle. It would be conceivable for the first fuel data to have been ascertained (in the form of fuel mixture data) using an example of the method according to the invention within the scope of a preceding fueling operation, and stored on the memory device. It would also be conceivable for the first fuel data to have been collected within the scope of the very first fueling operation, i.e., at the point in time when the fuel tank has been filled with a fuel for the first time, and stored on the memory device. Furthermore, it would also be conceivable for the first fuel data to be or have been collected using a fuel detection device of the vehicle and also stored on the memory device of the vehicle.

The ascertained and/or retrieved first fuel data can be characteristic of a quantity of the first fuel in the fuel tank of the vehicle. In other words, the first fuel data include data concerning a volume and/or a mass of the first fuel (in the fuel tank of the vehicle). These data are preferably collected using a suitable sensor device of the vehicle.

The second fuel data can be received by means of a data transfer device of the vehicle, with the second fuel data preferably being retrieved from a nonvolatile external memory device, in particular an external (backend) server. In one preferred method, the second fuel data are transferred via a wireless or wired communication link. In one preferred method, the second fuel data are provided by a manufacturer of the second fuel or by an operator of the filling station. In one preferred method, a transfer of the second fuel data takes place using a plug connection, in particular via a fuel dispenser or a filler neck of the fuel dispenser at the filling station. In an example, a transfer of the second fuel data takes place wirelessly. It would be conceivable for the second fuel data to be transferred between a data transfer device of the filling station and the data transfer device of the vehicle or of the device for carrying out at least one vehicle function (described in greater detail below).

The proposed method offers the advantage that data may be used which are available or present anyway from the manufacturer of the second fuel or from the filling station. Transport of fuel involves hazardous material transport, so that the driver of the tank truck must submit safety data sheets in which the components of the fuel (analysis variables, fractional portions, possibly fuel variables) are itemized in detail. It would be conceivable for the second fuel data to be stored on a memory device of the filling station, and for the transfer of the second fuel data to take place between this memory device of the filling station and the vehicle. It would also be conceivable for a link to be established between the vehicle and a server of the manufacturer of the second fuel, via the filling station.

Tank data can be transferred to the vehicle (in addition to the second fuel data), the tank data being characteristic of a position of the filling station or of the fuel dispenser of the filling station, and/or characteristic of a point in time of the fueling operation. In other words, data are additionally transferred which allow a determination to be made in retrospect concerning when, and with which fuel, a vehicle has been fueled. The proposed method is of interest in cases where “green fuel” will become established in the future, and manufacturers also have an interest in being able to demonstrate that the pumped fuel is a green fuel. In other words, it may thus be easily demonstrated that a green fuel has been pumped and used. The tank data are preferably characteristic of a quantity (volume or mass) of the pumped second fuel, and the tank data are preferably taken into account in ascertaining the fuel mixture.

The second fuel data can be ascertained based on at least one digital twin, the digital twin preferably in particular being a forgery-proof certificate with regard to the second fuel and/or with regard to a manufacturer of the second fuel. In one preferred method, such a certificate is transferred along the transport route, in particular between the manufacturer and the end customer, via the filling station.

At least one vehicle variable and preferably a plurality of vehicle variables can be ascertained based on the ascertained fuel mixture data, using a trained machine learning exhaust gas determination model. At least one combustion variable for the fuel mixture can be (initially) ascertained, based on the ascertained fuel mixture data (of the fuel mixture to be combusted), using the trained exhaust gas determination model. The at least one combustion variable can be characteristic of a combustion property of the fuel mixture, and can be characteristic of an exhaust gas composition, a pollutant level, and/or an efficiency (effective efficiency) for the combustion of the fuel mixture in the engine of the vehicle.

In other words, for example the particular exhaust gas composition or the particular efficiency (effective efficiency) that is expected for the fuel mixture during combustion in the engine of the vehicle is thus ascertained. As explained in greater detail below, the exhaust gas determination model is or has been trained based on a training data set that includes a plurality of vehicle variables. The vehicle variables used within the scope of the training of the exhaust gas determination model are preferably characteristic of at least one vehicle function, in particular of an adjustment variable of the vehicle or a portion of the vehicle for or during performance of this vehicle function. For example, the vehicle function is a drive function of the vehicle as a result of combustion of the fuel in the engine. In this case, the vehicle variable can be characteristic of an adjustment variable of the drive train of the vehicle, and is thus preferably characteristic of a drive operating strategy of the drive train of the vehicle. In other words, an ascertained vehicle variable can be characteristic of at least one operating parameter of a drive train of the vehicle.

The vehicle function can be an output of the ascertained combustion variable. It would be conceivable for the at least one ascertained combustion variable to be provided for output in particular to a user of the vehicle or to an external entity. This offers the advantage that the user of the vehicle obtains information concerning, for example, the exhaust gas composition to be expected from combustion of the fuel mixture at that time. The at least one ascertained vehicle variable can be a control command for storing the ascertained combustion variable and/or for outputting the ascertained combustion variable. The at least one ascertained vehicle variable can be characteristic, for example, of an exhaust gas composition to be expected from combustion of the fuel mixture. An output of the ascertained combustion variable preferably takes place via a display device of the vehicle, in particular via the human-machine interface (HMI).

At least one combustion variable (for the fuel mixture) can be ascertained based on the ascertained fuel mixture data, and at least one vehicle variable can be ascertained or derived based on the at least one combustion variable. The ascertained vehicle variable can be characteristic of the vehicle function to be carried out, and in particular is characteristic of at least one adjustment variable of the vehicle for carrying out the vehicle function. In other words, the at least one vehicle variable contains data or instructions (in the form of control commands, for example) with regard to the vehicle function to be carried out. According to the above example, the vehicle function may be a drive function of the vehicle. In this case the ascertained vehicle variable contains instructions or parameters for the drive train of the vehicle, or control commands for an engine control unit. For example, the vehicle variable is characteristic of a compression of the fuel during combustion in the engine, or is characteristic of an injection setting.

In an example, (initially) at least one combustion variable can be ascertained based on the ascertained fuel mixture data, and at least one vehicle variable can be ascertained and/or derived therefrom. When ascertaining the at least one vehicle variable, it would be conceivable for at least one, and preferably more than one, vehicle variable to be taken into account as a combustion variable. The at least one combustion variable can be taken into account in such a way that an optimized and/or predefined combustion of the fuel mixture in the engine is achieved. For this purpose it would conceivable, for example, for a combustion variable in the form of an exhaust gas composition to not be optimized for a global minimum of CO₂, since losses in efficiency must be accepted when the absolute minimum is reached. The vehicle variable can be ascertained in such a way that a compromise is made between a reduction in exhaust gas emissions and an optimal efficiency (effective efficiency of the combustion). The at least one vehicle variable can be ascertained in such a way that during combustion of the fuel mixture the regulatory requirements are met, while at the same time the highest possible efficiency is achieved.

Based on the ascertained fuel mixture data and based on the at least one ascertained combustion variable, at least one vehicle variable and a combustion variable associated with the at least one vehicle variable can be ascertained, using the trained machine learning exhaust gas determination model. The ascertained fuel mixture data and the at least one ascertained combustion variable are preferably used as an input variable for the machine learning exhaust gas determination model, with the at least one vehicle variable and a combustion variable associated with the at least one vehicle variable being obtained as an output variable.

The trained machine learning exhaust gas determination model can generate at least one combustion variable as an output variable, using the ascertained fuel mixture data as an input variable. The trained machine learning exhaust gas determination model preferably generates at least one vehicle variable and a combustion variable associated with the at least one vehicle variable as an output variable, using the ascertained fuel mixture data and the at least one ascertained combustion variable as an input variable.

The at least one ascertained vehicle variable can be characteristic of at least one operating parameter, preferably characteristic of a plurality of operating parameters, of the drive train of the vehicle. The associated combustion variable can be characteristic, for example, of an exhaust gas composition resulting from the combustion of the fuel mixture, using the operating parameters established by the at least one vehicle variable. In other words, a set of operating parameters is ascertained, and an exhaust gas composition to be expected for this operating parameter is ascertained.

The associated combustion variable is once again used, together with the ascertained fuel mixture data, as an input variable for the machine learning exhaust gas determination model, with at least one further vehicle variable and a further combustion variable associated with this vehicle variable being ascertained. This procedure preferably involves an optimization process or a method for ascertaining an optimized vehicle variable. An optimized vehicle variable can be understood to mean a vehicle variable that is characteristic of a set of operating parameters, among which an optimal combustion variable is contained. In other words, an optimized vehicle variable and thus a plurality of optimized operating parameters is/are ascertained in such a way that an optimized combustion variable is obtained. As stated above, an optimized combustion variable can be understood to mean a compromise between a reduction in exhaust gas emissions and an optimal efficiency.

The at least one combustion variable that is ascertained based on the ascertained fuel mixture data can be used as the starting point for ascertaining the at least one optimized vehicle variable (starting point of the optimization process). It would also be conceivable to use a measured combustion variable as the starting point for ascertaining the at least one optimized vehicle variable. This is possible, for example, for a fuel mixture to be combusted for which the fuel mixture data as well as at least one combustion variable are known.

The ascertained vehicle variable can be characteristic of an adjustment variable of at least one, preferably of a plurality of, parameters (operating parameters) of the drive train of the vehicle. In other words, the ascertained vehicle variable can be characteristic of a drive operating strategy, and contains appropriate instructions or control commands for the drive train of the vehicle or for a control unit of the drive train. The at least one vehicle function can be carried out based on the ascertained vehicle variable. In other words, after a fueling operation the composition of the new fuel mixture is ascertained, and on this basis a drive operating strategy is adapted in such a way that the combustion of the new fuel mixture takes place in an optimal manner.

This procedure can be repeated after each fueling operation. This offers the advantage that the drive train of the vehicle is always optimally adapted to the fuel at the time, which is beneficial with regard to fuel consumption and reduced pollutant emissions. In one preferred method, during ascertainment of the at least one vehicle variable at least one, and preferably a plurality of, vehicle variables is/are taken into account which have been used during a training process in creating the trained machine learning exhaust gas determination model. In other words, the vehicle variables utilized within the scope of the training process for the model are used to derive at least one vehicle variable on the basis of the combustion variable (ascertained based on the ascertained fuel mixture data).

The vehicle function can be a drive function of the vehicle, and the at least one ascertained vehicle variable is characteristic of at least one adjustment variable of the drive train of the vehicle, the adjustment variable of the drive train including at least one operating parameter and preferably a plurality of operating parameters. In one preferred method, the at least one vehicle variable includes a control command for adapting at least one adjustment variable of the drive train of the vehicle or for adapting at least one operating parameter, and preferably for carrying out the vehicle function based on the adapted adjustment variable or based on the at least one adapted operating parameter.

The at least one vehicle variable can be characteristic of at least one adjustment variable of the drive train of the vehicle, and can be characteristic of an adjustment variable of a fuel system, an adjustment variable of an air pathway, an adjustment variable of an ignition system, an adjustment variable of a mechanical component (mechanics), an adjustment variable of a process material, an adjustment variable of an exhaust gas pathway, and/or is characteristic of an operating mode.

The at least one vehicle variable can be characteristic of an adjustment variable of the drive train, the adjustment variable of the drive train including or containing at least one and preferably a plurality of operating parameters, and/or a control command for adapting at least one operating parameter and preferably a plurality of operating parameters. In other words, the vehicle variable is characteristic of at least one, preferably a plurality of, operating parameters.

The at least one vehicle variable can be characteristic of an adjustment variable of the fuel system, and the at least one vehicle variable can be characteristic of at least one operating parameter selected from a group of operating parameters comprising a flow volume, an injection system, a start of injection, an end of injection, a number of injections, an injection quantity, a distribution of the injection quantity, an injection pressure, and the like as well as combinations thereof.

The at least one vehicle variable can be characteristic of an adjustment variable of the air pathway, and the at least one vehicle variable can be characteristic of at least one operating parameter selected from a group of operating parameters comprising an air charge path, a charge pressure, a charge air temperature, an (air-fuel ratio) lambda number, an exhaust gas recirculation (AGR) rate, a torque limitation due to intervention in the air pathway, and the like as well as combinations thereof.

The at least one vehicle variable can be characteristic of an adjustment variable of the ignition system, and the at least one vehicle variable can be characteristic of at least one operating parameter selected from a group of operating parameters comprising an ignition point, a knock control (advancement or retardation of the ignition point), and the like as well as combinations thereof.

The at least one vehicle variable can be characteristic of an adjustment variable of the mechanics, and at least the at least one vehicle variable is characteristic of a setting of a camshaft, of a crankshaft, of a transmission, of a hybrid mode, of operational stability, or of a piston and/or a connecting rod, wherein the at least one vehicle variable can be characteristic of at least one operating parameter selected from a group of operating parameters, the at least one operating parameter may be selected from a group of operating parameters comprising a phase setting (camshaft), a stroke adjustment (camshaft), a cam profile adjustment (camshaft), a variable compression (crankshaft), shift points (transmission), a shift strategy (transmission), a ratio of internal combustion engine (ICE) to electric engine (E) (hybrid drive), a cylinder peak pressure regulation (operational stability), and/or a variable compression (piston or connecting rod), and the like as well as combinations thereof.

The at least one vehicle variable can be characteristic of an adjustment variable of the process materials, and the at least one vehicle variable can be characteristic of a setting of cooling, of an oil system, or of a maintenance service, wherein the at least one vehicle variable can be characteristic of at least one operating parameter selected from a group of operating parameters comprising an adaptation of the engine cooling, an oil change interval, a service interval, and the like as well as combinations thereof.

The at least one operating parameter can be characteristic of an adjustment variable of the exhaust gas pathway, and can be characteristic of a setting for a particulate filter, a turbocharger, and/or exhaust gas emissions, wherein the at least one vehicle variable can be characteristic of at least one operating parameter selected from a group of operating parameters comprising a particulate filter regeneration interval, a variable turbine geometry (VTG) or wastegate (WG) turbine setting (with an adjustment of the exhaust gas temperature upstream from the turbine, more or less torque could be permitted, under the condition that lambda=1), an adaptation of the exhaust gas emissions by combining various operating parameters, and the like as well as combinations thereof.

The at least one operating parameter can be characteristic of an adjustment variable of the operating mode, and the at least one vehicle variable can be characteristic of at least one operating parameter selected from a group of operating parameters comprising an engine start, a catalytic converter heating operation, a half-engine operation, a particulate filter regeneration, and the like as well as combinations thereof.

The ascertainment of the at least one vehicle variable preferably takes place using the trained machine learning exhaust gas determination model. A method for creating such a trained machine learning exhaust gas determination model is explained in greater detail below. The trained machine learning exhaust gas determination model can be configured in such a way that the ascertained fuel mixture data are used as an input variable, and at least one combustion variable is obtained as an output variable, wherein at least one vehicle variable is ascertained or derived based on the ascertained combustion variable. The ascertained vehicle variable can be characteristic of an optimized drive operating strategy. In this context, optimization can be understood to mean a reduction of exhaust gas emissions and an increase in efficiency while at the same time meeting regulatory requirements.

In a further step of the method according to the invention, the at least one vehicle function can be carried out based on the ascertained vehicle variable, with preferably at least one operating parameter and preferably a plurality of operating parameters of the drive strategy being adapted based on the at least one, preferably the plurality of, ascertained vehicle variable(s). In this context, adaptation can be understood to mean a change in at least one operating parameter in such a way that the exhaust gas emissions resulting from the combustion of the fuel mixture are reduced and efficiency is increased.

Further, the ascertained second fuel data may not contain a plurality of analysis variables and associated fractional portions, and instead, data concerning a classification of the second fuel are ascertained. Such a classification could be “Research Octane Number (RON) 98” or “paraffinic diesel,” for example. The first fuel data and/or second fuel data may not transferred. In this case, data concerning the fuel are derived based on in-vehicle measurement variables that are detected by detection devices, for example a fuel detection device or a lambda sensor. These derived data or the detected measurement variables are preferably used as input variables for the trained machine learning exhaust gas determination model when ascertaining the combustion variables.

A control loop can be provided, via which at least one vehicle variable and in particular an electrically controllable engine parameter (operating parameter) may be deduced based on an ascertained combustion variable (exhaust gas composition). In one preferred method, fuel tank data (as described above) that are characteristic of a position of a filling station and characteristic of the pumped fuel are ascertained. It would also be conceivable to use the data from a plurality of different vehicles (use of swarm data) for ascertaining data concerning a pumped fuel.

Environmental variables can be taken into account in ascertaining the at least one vehicle variable. Such an environmental variable can be characteristic of an ambient temperature or an ambient pressure. Taking into account the environmental conditions offers the advantage that the drive train may be controlled even more effectively, since for low or high external pressures, for example, it is necessary to throttle power, since otherwise the turbocharger used would turn too rapidly.

The present invention is further directed to a computer-implemented method for creating a trained machine learning exhaust gas determination model for ascertaining at least one combustion variable of a predefined fuel, using fuel data that are characteristic of a composition of the predefined fuel, wherein the fuel data concerning the predefined fuel include at least one analysis variable and a fractional portion associated with the analysis variable, wherein the analysis variable in each case is characteristic of a group of compounds from the predefined fuel that have at least one predefined functionality, and wherein the fractional portion is characteristic of a quantity fraction of the compounds that are present in the particular fuel and grouped in the group characterized by the analysis variable, with a step of providing a trainable machine learning exhaust gas determination model that includes a set of trainable parameters and that generates at least one combustion variable as an output variable, based on fuel data collected for a predefined fuel or data derived therefrom as an input variable, wherein the combustion variable is characteristic of at least one combustion property of the fuel.

A training data set can be generated which includes a plurality of collected or ascertained fuel data concerning training fuels as well as a plurality of measured combustion variables, with the combustion variables in each case being characteristic of at least one combustion property of the particular training fuel, and a plurality of vehicle variables, with the vehicle variables being characteristic of at least one adjustment variable of an engine that is used for combustion of the training fuels. In a further step of the method according to the invention, the machine learning exhaust gas determination model is trained based on the training data set.

A machine learning model (trainable machine learning exhaust gas determination model) can be provided, and can be trained based on training fuel mixtures or data sets with regard to these training fuel mixtures.

The trainable machine learning exhaust gas determination model can be based on an (artificial) neural network. The neural network can be selected from a group of neural networks comprising recurrent neural networks (RNNs), long short-term memory networks (LSTMs), gated recurrent units (GRUs), temporal convolutional networks (TCNs), transformer networks, convolutional neural networks (CNNs), autoencoders, time delay neural networks (TDNNs), and/or echo state networks (ESNs), graph neural networks (GNNs), or the like.

The neural network can be a recurrent neural network (RNN) and/or a long short-term memory network (LSTM) and/or a temporal convolutional network (TCN) and/or an echo state network (ESN) and/or a graph neural network (GNN).

The trained model can be a, in particular trainable, machine learning model that includes a set of in particular trainable parameters which are set to values that have been learned as the result of a training process.

The training process or a training method can be selected from a group of training methods comprising supervised learning, unsupervised learning, semi-supervised learning, reinforcement learning, transfer learning, ensemble learning, cross-validation, Bayesian methods, online learning, anomaly detection, and the like. The training method can be particularly preferably supervised learning and/or reinforcement learning and/or cross-validation.

For this purpose a training data set can be generated which contains a plurality of collected and/or ascertained fuel data concerning training fuels. Such fuel data can be characteristic of a composition and/or property of the particular training fuel mixture.

Fuel data can be generated and/or ascertained for a training fuel and preferably for each training fuel (as described above in conjunction with the first fuel data and second fuel data). The fuel data concerning the particular training fuel in each case can include at least one analysis variable and at least one fractional portion associated with the analysis variable. The analysis variable can be characteristic of a group of compounds from the training fuel which have at least one predefined functionality. The fractional portion can be characteristic of a quantity fraction of the compounds that are present in the training fuel and grouped in the group characterized by the analysis variable.

“Collection of fuel data” can be understood in particular to mean receipt of the fuel data transferred via a data transfer device and/or retrieval of the fuel data from an in particular nonvolatile memory device (for example, an external memory device such as an external (backend) server), using an in particular processor-based device, preferably as described in greater detail below, for creating a trained machine learning exhaust gas determination model for ascertaining at least one combustion variable, so that (as a result of the collection) fuel data are provided for data processing of the fuel data.

Further, “collection of fuel data” may additionally or alternatively be understood to mean ascertainment and/or generation of the fuel data. This could take place via computational determination, for example by interpolation and/or extrapolation of predefined data values (of at least one or multiple similar fuels, for example) and/or by experimental generation or experimental determination and/or experimental measurement of the fuel data.

The training data set for at least one training fuel and preferably for a plurality of training fuels can include at least one, and preferably a plurality of, fuel variable(s) that is/are used as input variables for training the machine learning operating variable determination model.

In an example, (in addition to the fuel data) combustion measurement data and/or at least one combustion variable derived therefrom are collected and/or ascertained for each training fuel. In one preferred method, these data are collected using an (engine) test stand. The training fuels are combusted in a test engine (under realistic conditions), and data concerning the combustion are appropriately collected. The collected and/or ascertained combustion data or the combustion variable derived therefrom are preferably an exhaust gas composition of the exhaust gases produced during the combustion of the training fuel. The combustion data preferably include further data also concerning fine particulate and/or soot particle loading or data concerning a pollution level (for example, with regard to the presence of nitrogen oxides). The combustion variable can be a variable that is derived from the combustion measurement data. This combustion variable can be characteristic of an exhaust gas composition, an exhaust gas characteristic, a fraction of nitrogen oxides in the exhaust gas, a pollution level, a fine particulate loading, a soot particle loading, an effectiveness, a duration, and/or for an efficiency (of the engine).

The combustion variable (combustion measurement data and/or combustion variables derived therefrom) can be retrieved, analogously to the fuel data, from an in particular nonvolatile memory device (for example, an external memory device such as an external (backend) server). This offers the advantage that for training fuels which have already been measured at the test stand, a new measurement does not have to be performed.

The training data set can contain a plurality of vehicle variables, the vehicle variables being characteristic of at least one adjustment variable or of at least one operating parameter of the drive train of the (engine) test stand. In other words, the test stand represents a drive train of a vehicle having an internal combustion engine, and the vehicle variables contain data concerning the drive train. At least one variable, and preferably the plurality of vehicle variables, can be characteristic of at least one operating parameter, preferably of a plurality of operating parameters.

The training data set used includes data sets concerning a plurality of training fuels, and preferably includes more than 50, preferably more than 100, and particularly preferably more than 150, data sets concerning training fuels. In an example, for generating the data sets for the training data set at least one and preferably a plurality of settings or operating parameters (vehicle variables) is/are held constant, and at least one other, preferably a plurality, of other settings or operating parameters (vehicle variables) are varied. It would be conceivable for parameters that have been proven as optimal in the past (optimization provides no further appreciable advantage), or which during ongoing operation cannot be adjusted easily or at all (for technical reasons, for example), to be held constant. For example, an ignition angle or charge pressure as well as a camshaft adjustment may be varied.

The standard limits of EN 228 can be taken into account in selecting the training fuels.

The generated training data or the generated training data set can be characteristic of the engine (test stand) used. The generated training data or the trained exhaust gas determination model can be transferable to other related engines. “Related engines” can be understood to mean engines which with regard to a stroke-to-bore ratio (the ratio of the piston stroke to the cylinder diameter) deviate by no more than 15% and preferably by no more than 10%. Furthermore, related engines can be understood to mean engines that are similar to one another with regard to a position of the spark plug(s) (for example, centrally in the combustion chamber) and of an injector (for example, lateral). In addition, related engines can be understood to mean engines that are similar to one another with regard to valve settings and inflow behavior. Moreover, similar engines are included, for example naturally aspirated engines or turbocharged engines, with present-day naturally aspirated engines possibly being less relevant.

The present invention is further directed to an in particular processor-based device for carrying out at least one vehicle function of a vehicle depending on a fuel mixture to be combusted, the device being suited and intended for ascertaining fuel mixture data concerning the fuel mixture to be combusted, wherein the ascertained fuel mixture data are characteristic of at least one property of the fuel mixture to be combusted. According to the invention, the device is suited and intended for ascertaining at least one vehicle variable for carrying out the at least one vehicle function based on the ascertained fuel mixture data, using a trained machine learning exhaust gas determination model, wherein the trained machine learning exhaust gas determination model, using the ascertained fuel mixture data as an input variable, generates at least one combustion variable as an output variable, the combustion variable being characteristic of at least one combustion property of the fuel mixture to be combusted. Furthermore, the device is suited and intended for carrying out the at least one vehicle function based on the ascertained vehicle variable.

The device for carrying out at least one vehicle function can include a data transfer device that is configured to retrieve first fuel data from a memory device of the vehicle. The data transfer device can be configured to retrieve second fuel data from a nonvolatile external memory device, in particular an external (backend) server. The data transfer device can be suited and intended for transferring the second fuel data via a wireless or wired communication link. The vehicle preferably has a communication interface that is connectable to a data transfer device of the filling station via a plug connection. The data transfer device of the device can be configured to establish a communication link with the data transfer device of the filling station via the communication interface of the vehicle. The second fuel data are preferably transferred via this communication link.

The device for carrying out at least one vehicle function can be configured to retrieve first fuel data from a fuel detection device of the vehicle or to retrieve first fuel data, which have been collected by a fuel detection device of the vehicle and stored on the memory device of the vehicle, from a memory device of the vehicle.

The device for carrying out at least one vehicle function can be configured to ascertain fuel mixture data concerning the fuel mixture to be combusted, based on the retrieved first fuel data and second fuel data, using an (above-described) mixing model. The device for carrying out at least one vehicle function can be configured to ascertain at least one combustion variable based on the ascertained fuel mixture data, using the trained machine learning exhaust gas determination model, and to ascertain or derive at least one vehicle variable, preferably based on the ascertained at least one combustion variable. The device for carrying out at least one vehicle function is also preferably configured to carry out at least one vehicle function based on the ascertained at least one vehicle function. It would be conceivable for the device for carrying out at least one vehicle function to be configured to generate at least one control command, based on the ascertained vehicle variable, in order to activate the appropriate component of the vehicle. The at least one vehicle function can be a drive of the vehicle.

The device for carrying out at least one vehicle function can be configured, suited, and/or intended for carrying out the above-described method for carrying out at least one vehicle function as well as all method steps described above in conjunction with the method (or an example of the method), individually or in combination with one another. Conversely, the method may be provided with all features described within the scope of the device for carrying out at least one vehicle function, individually or in combination with one another.

The present invention is further directed to a processor-based device for creating a trained machine learning exhaust gas determination model for ascertaining at least one combustion variable of a predefined fuel, using fuel data that are characteristic of a composition of the predefined fuel, wherein the fuel data concerning the predefined fuel include at least one analysis variable and a fractional portion associated with the analysis variable, the analysis variable in each case being characteristic of a group of compounds from the predefined fuel that have at least one predefined functionality, and the fractional portion being characteristic of a quantity fraction of the compounds that are present in the particular fuel and grouped in the group characterized by the analysis variable.

In addition, the device is suited and intended for providing a trainable machine learning exhaust gas determination model that includes a set of trainable parameters and that generates at least one combustion variable as an output variable, based on fuel data collected for a predefined fuel or data derived therefrom as an input variable, the combustion variable being characteristic of at least one combustion property of the fuel. Furthermore, the device is suited and intended for generating a training data set that includes a plurality of collected fuel data concerning training fuels as well as a plurality of measured combustion variables, the combustion variables in each case being characteristic of at least one combustion property of the particular training fuel, and a plurality of vehicle variables, the vehicle variables being characteristic of at least one adjustment variable of an engine that is used for combustion of the training fuels. In addition, the device is suited and intended for training the machine learning exhaust gas determination model based on the training data set.

The device for creating a trained exhaust gas determination model can be configured, suited, and/or intended for carrying out the above-described method for creating a trained exhaust gas determination model as well as all method steps described above, individually or in combination with one another, in conjunction with the method (or an example of the method). Conversely, the method may be provided with all features described within the scope of the device for creating a trained exhaust gas determination model, individually or in combination with one another.

The present invention is further directed to a vehicle, in particular a motor vehicle, having a device for carrying out at least one vehicle function according to an example described above. The vehicle may in particular be a (motorized) road vehicle.

A vehicle may be a motor vehicle which is a motor vehicle controlled by the driver him/herself (“driver only”), or a semiautonomous, autonomous (for example, autonomy level 3 or 4 or 5 (SAE J3016 standard)), or self-driving motor vehicle. Autonomy level 5 refers to fully automatically driving vehicles. The vehicle may also be a driverless transport system. The vehicle can be controlled by a driver or can drive autonomously. Furthermore, besides a road vehicle the vehicle may be an air taxi, an airplane, or some other means of transportation or some other type of vehicle, for example an aircraft, watercraft, or rail vehicle.

The above-described methods and/or devices can be likewise applicable for use in turbines, airplanes, and/or ships.

The present invention is further directed to a computer program, computer readable medium, or computer program product that includes a program, in particular a program code, that carries out at least some and preferably all method steps of the method according to the invention (method for carrying out at least one vehicle function and method for creating a trained machine learning exhaust gas determination model, and that preferably represents and encodes one of the described examples and that is designed to be executed by a processor device.

The present invention is further directed to a data memory on which at least one example of the computer program according to the invention or an example of the computer program is stored.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a vehicle having a device according to the invention for carrying out at least one vehicle function according to an example,

FIG. 2 shows a schematic illustration of an example of a method according to the invention for carrying out at least one vehicle function,

FIG. 3 shows a schematic illustration of an example of a method according to the invention for creating a trained machine learning exhaust gas determination model, and

FIG. 4 shows a schematic illustration of an example of a method according to the invention for carrying out at least one vehicle function.

### DETAILED DESCRIPTION

FIG. 1 shows a vehicle 1 having a device for carrying out at least one vehicle function 10 according to an example. The vehicle 1 also has a data transfer device 12 that is suited for retrieving or receiving second fuel data 40 from a second memory device 36. In addition, the vehicle 1 has a memory device 14 on which an example of a computer program according to the invention can be stored. The memory device 14 can be the same memory device 34 on which the first fuel data 38 are stored. In an example, the vehicle 1 also has a (fuel) detection device 16 that is configured to collect the fuel data 42 using an (onboard) sensor device. Reference numeral 18 denotes a drive train of the vehicle 1.

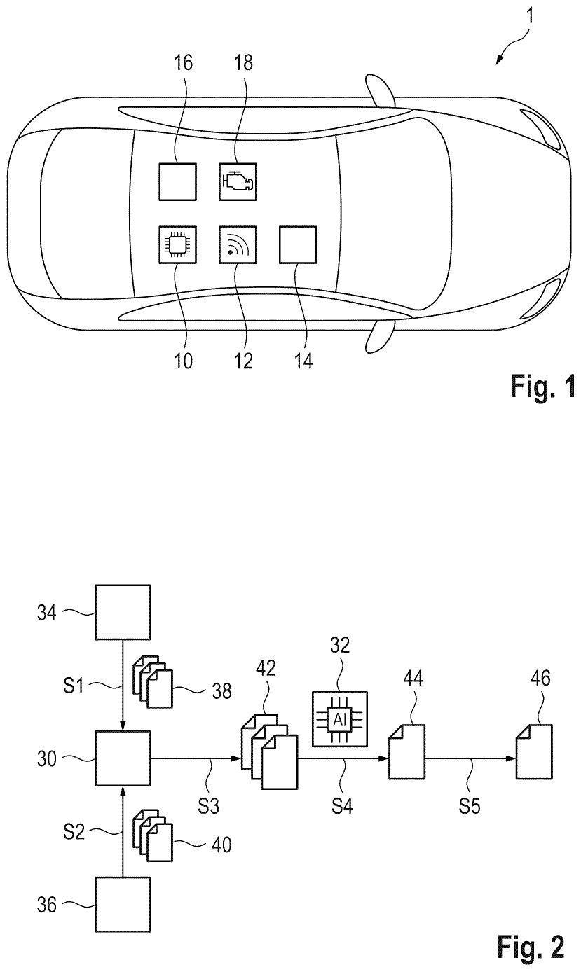

FIG. 2 shows a schematic illustration of an example of a method according to the invention for carrying out at least one vehicle function. Reference numeral 34 denotes a first memory device on which the first fuel data 38 are stored. The first memory device 34 can be a memory device of the vehicle 1. Reference numeral 36 denotes a second memory device on which the second fuel data 40 are stored. The second memory device 36 can be an external nonvolatile memory, and in particular is an external (backend) server. The second memory device can be a memory device of a filling station or of a manufacturer of the second fuel.

First fuel data 38 are retrieved from the first memory device 34 in a step S1. The first fuel data 38 are preferably data concerning a first fuel that is present in the fuel tank of the vehicle. The first fuel data 38 preferably include a plurality of analysis variables and fractional portions associated with same. The first fuel data 38 preferably include a plurality of fuel variables. In other words, the first fuel data 38 are characteristic of a composition of the first fuel and characteristic of the properties of the first fuel. The first fuel data 38 preferably also include data concerning a quantity or a volume (or mass) of the first fuel (in the fuel tank of the vehicle).

Second fuel data 40 are retrieved from the second memory device 36 in a further step S2. The retrieval preferably takes place using the data transfer device 12 of the vehicle 1. The second memory device 36 can be an external (backend) server. The retrieval of the second fuel data 40 preferably takes place within the scope of a fueling operation at a filling station. A wireless or wired connection to the vehicle 1 can be established (via a pump nozzle, for example) for transferring the second fuel data 40. The second fuel data 40 are preferably data concerning a pumped second fuel.

The second fuel data 40 preferably include a plurality of analysis variables and fractional portions associated with same. The second fuel data 40 preferably include a plurality of fuel variables. In other words, the second fuel data 40 are characteristic of a composition of the second fuel and characteristic of the properties of the second fuel. The second fuel data 40 preferably also contain data concerning a quantity or a volume of the second fuel component (that has been pumped at the filling station).

The fuel mixture data 42 are ascertained in a further step S3 based on the retrieved first fuel data 38 and second fuel data 40, using a mixing model 30. If the first fuel data 38 and the second fuel data 40 include only an analysis variable and fractional portions, for example, the fuel mixture data 42 may be ascertained using a simple mathematical model (combinatorics). If, however, in addition to the analysis variables and fractional portions the ascertained first fuel data 38 and second fuel data 40 also contain fuel variables (for example, data concerning a vapor pressure or an octane number) and such a fuel variable is also to be ascertained for the fuel mixture data 42, this is not possible using a simple mathematical model. In this case a trained fuel property determination model, known from DE 10 2022 207 017 by the applicant, for example, may be used as a mixing model 30. The fuel mixture data 42 are preferably characteristic of a composition of the fuel mixture to be combusted and characteristic of the properties of the fuel mixture to be combusted. The fuel mixture to be combusted can be formed from the first fuel and the second fuel.

At least one combustion variable 44 is ascertained in a further step S4 based on the fuel data 42, using the trained machine learning exhaust gas determination model 32. At least one vehicle variable 46 can be ascertained or derived in a further step S5 based on the ascertained combustion variable 44. The vehicle function can be an output of the ascertained combustion variable 44. The ascertained vehicle variable 46 can be characteristic of a control command for storing and/or outputting the ascertained combustion variable 44.

A vehicle function is carried out in a further step, based on the ascertained vehicle variable 46. At least one operating parameter of the drive train 18 of the vehicle 1 is adapted. The at least one ascertained vehicle variable 46 can be characteristic of at least one operating parameter, and can be characteristic of a value of this operating parameter. The vehicle variable 46 can be used to adapt an operating parameter of the drive train to the fuel mixture (fuel mixture to be combusted) that results from the fueling operation. For example, an adjustment variable may be adapted to the injection system or to a compression of the fuel.

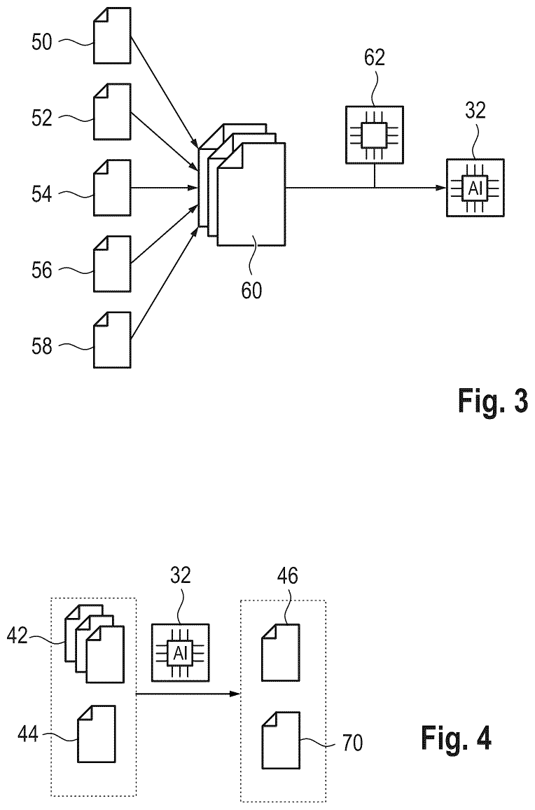

FIG. 3 shows a schematic illustration of an example of a method according to the invention for creating a trained exhaust gas determination model 32. Initially an untrained (trainable) exhaust gas determination model 62 is provided, and is trained with a training data set 60. The training data set 60 includes a plurality of analysis variables 50, a plurality of fractional portions 52, a plurality of fuel variables 54, and/or a plurality of vehicle variables 56. These analysis variables 50, fractional portions 52, and fuel variables 54 may, for example, be ascertained based on measurements (a complete chemical analysis, for example) or retrieved from a database. It would be conceivable for the analysis variables 50, the fractional portions 52, and the fuel variables 54 to be obtained based on a chemical analysis of a fuel mixture.

The group of oxygenates which are present in the fuel mixture in a fraction of 20 vol % (fractional portion 52) represents an example of an analysis variable 50. An octane number of 95 represents an example of a fuel variable 54. The training data set 60 also contains at least one vehicle variable 56. This is a variable that is characteristic of an operating parameter of the engine or of a component of the engine or of a software or hardware setting of the engine or of the engine control. In other words, the vehicle variable 56 is characteristic of at least one property/setting of an engine that is used for combusting the training fuel and for ascertaining the combustion variables 58, and that can be characteristic of at least one operating parameter of the drive operating strategy of the drive train of the vehicle. An example of a vehicle variable 56 is characteristic of a set compression ratio of 10:1, for example. In the present case the variables 50 through 56 are used as input variables for the machine learning exhaust gas determination model.

The training data set 60 also contains at least one combustion variable 58. Such a combustion variable 58 is characteristic of at least one property of the fuel mixture for the combustion, for example at an engine test stand. An example of a combustion variable 58 is characteristic of an exhaust gas composition, and contains, for example, a fraction of fine particulate in the exhaust gas or a fraction of nitrogen oxides in the exhaust gas. In the present case the combustion variable 58 is used as an output variable for the machine learning exhaust gas determination model. In other words, the training data set 60 contains a plurality of input variables (variables 50, 52, 54, 56) and output variables (combustion variables 58).

The training data set 60 is used for training an untrained exhaust gas determination model 62, as a result of which a trained exhaust gas determination model 32 is obtained which can be used in a method according to FIG. 2.

FIG. 4 shows a schematic illustration of an example of a method according to the invention for ascertaining at least one vehicle variable 46. The ascertained fuel mixture data 42 and the at least one ascertained combustion variable 44 are used as an input variable for the trained machine learning exhaust gas determination model 32, with at least one vehicle variable 46 and a combustion variable 70 associated with the at least one vehicle variable 46 being obtained as an output variable. For example, the associated combustion variable 70 is characteristic of a composition of the exhaust gas which results from combusting the fuel mixture using the ascertained plurality of operating parameters (derived from the ascertained vehicle variable 46).

In other words, the ascertained combustion variable 44 is used as a starting point for ascertaining the at least one vehicle variable 46, and preferably for ascertaining at least one optimized vehicle variable. It would also be possible to use a measured combustion variable as a starting point for ascertaining the at least one optimized vehicle variable, provided that for a fuel mixture to be combusted, the fuel mixture data 42 as well as the combustion variable 44 are known (from measurement data). In one preferred method, the ascertainment of the at least one vehicle variable 46 is repeated until an optimized combustion variable 70, and correspondingly at least one optimized vehicle variable 46, is obtained.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for carrying out at least one vehicle function of a vehicle, depending on a fuel mixture to be combusted, the method comprising:
ascertaining fuel mixture data concerning the fuel mixture to be combusted, the ascertained fuel mixture data being characteristic of at least one property of the fuel mixture to be combusted;
ascertaining at least one vehicle variable for carrying out the at least one vehicle function based on the ascertained fuel mixture data, using a trained machine learning exhaust gas determination model, wherein the trained machine learning exhaust gas determination model, using the ascertained fuel mixture data as an input variable, generates at least one combustion variable as an output variable, the combustion variable being characteristic of at least one combustion property of the fuel mixture to be combusted; and
carrying out the at least one vehicle function based on the ascertained vehicle variable.

2. The method according to claim 1, wherein the fuel mixture to be combusted includes at least one first fuel and one second fuel, the first fuel being a fuel that is present in a fuel tank of the vehicle, and the second fuel being a fuel that is subsequently pumped into the fuel tank.

3. The method according to claim 2, wherein first fuel data and the second fuel data are ascertained, the first fuel data being characteristic of at least one property of the first fuel, and the second fuel data being characteristic of at least one property of the second fuel, and wherein the ascertainment of the fuel mixture data takes place based on the first fuel data and second fuel data.

4. The method according to claim 3, wherein the first fuel data and the second fuel data include at least one analysis variable and a fractional portion associated with the analysis variable, or a quantity variable/volume variable, or at least one fuel variable.

5. The method according to claim 1, wherein the at least one vehicle variable is characteristic of at least one adjustment variable of the drive train of the vehicle, and is characteristic of at least one adjustment variable of a fuel system, an adjustment variable of an air pathway, an adjustment variable of an ignition system, an adjustment variable of a mechanical component (mechanics), an adjustment variable of a process material, an adjustment variable of an exhaust gas pathway, and/or of an operating mode.

6. The method according to claim 3, wherein the first fuel data are retrieved from a nonvolatile memory device of the vehicle.

7. The method according to claim 3, wherein the second fuel data are received via a data transfer device of the vehicle, with the second fuel data being retrieved from a nonvolatile external memory device or an external (backend) server.

8. The method according to claim 1, wherein the second fuel data are ascertained based on at least one digital twin, the digital twin being a forgery-proof certificate with regard to a manufacturer of the second fuel.

9. A computer-implemented method for creating a trained machine learning exhaust gas determination model to ascertain at least one combustion variable of a predefined fuel, using fuel data that are characteristic of a composition of the predefined fuel, wherein the fuel data concerning the predefined fuel include at least one analysis variable and a fractional portion associated with the analysis variable, wherein the analysis variable is characteristic of a group of compounds from the predefined fuel that have at least one predefined functionality, and wherein the fractional portion is characteristic of a quantity fraction of the compounds that are present in the particular fuel and grouped in the group characterized by the analysis variable, the method comprising:
providing a trainable machine learning exhaust gas determination model that includes a set of trainable parameters and that generates at least one combustion variable as an output variable, based on fuel data collected for a predefined fuel or data derived therefrom as an input variable, the combustion variable being characteristic of at least one combustion property of the fuel;
generating a training data set that includes a plurality of collected fuel data concerning training fuels as well as a plurality of measured combustion variables, with the combustion variables being characteristic of at least one combustion property of the particular training fuel, and a plurality of vehicle variables, with the vehicle variables being characteristic of at least one adjustment variable of an engine that is used for combustion of the training fuels; and
training the machine learning exhaust gas determination model based on the training data set.

10. A device to carrying out at least one vehicle function of a vehicle depending on a fuel mixture to be combusted, the device ascertaining fuel mixture data concerning the fuel mixture to be combusted, the ascertained fuel mixture data being characteristic of at least one property of the fuel mixture to be combusted,
wherein the device ascertains at least one vehicle variable for carrying out the at least one vehicle function based on the ascertained fuel mixture data, using a trained machine learning exhaust gas determination model,
wherein the trained machine learning exhaust gas determination model generates at least one combustion variable as an output variable, using the ascertained fuel mixture data as an input variable, the combustion variable being characteristic of at least one combustion property of the fuel mixture to be combusted, and
wherein the device carries out the at least one vehicle function based on the ascertained vehicle variable.

11. A device for creating a trained machine learning exhaust gas determination model to ascertain at least one combustion variable of a predefined fuel, using fuel data that are characteristic of a composition of the predefined fuel,
wherein the fuel data concerning the predefined fuel include at least one analysis variable and a fractional portion associated with the analysis variable, the analysis variable being characteristic of a group of compounds from the predefined fuel and having at least one predefined functionality,
wherein the fractional portion is characteristic of a quantity fraction of the compounds that are present in the particular fuel and grouped in the group characterized by the analysis variable,
wherein the device provides a trainable machine learning exhaust gas determination model that includes a set of trainable parameters and generates at least one combustion variable as an output variable, based on fuel data collected for a predefined fuel or data derived therefrom as an input variable,
wherein the combustion variable is characteristic of at least one combustion property of the fuel,
wherein the device being generates a training data set that includes a plurality of collected fuel data concerning predefined training fuels as well as a plurality of combustion variables, the combustion variables being characteristic of at least one combustion property of the particular training fuel, and a plurality of vehicle variables,
wherein the vehicle variables are characteristic of at least one adjustment variable of an engine that is used for combustion of the training fuels,
wherein the device trains the machine learning exhaust gas determination model based on the training data set.

12. A vehicle comprising the device according to claim 10.
